(19) United States
(12) Patent Application Publication
(10) Pub. No.: US 2006/0043767 A1
(43) Pub. Date: Mar. 2, 2006

(54) Mounting apparatus

(76) Inventor: Lance Albert Lunson, Forth, Tasmania (AU)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/511,243

(22) PCT Filed: Apr. 15, 2003
(86) PCT No.: PCT/AU03/00449

§ 371 Date: Jul. 1, 2005

(30) Foreign Application Priority Data
Apr. 17, 2002 (AU) PS 1759
Apr. 1, 2003 (AU) 2003203469

(51) Int. Cl. B60R 15/00

(52) U.S. Cl. 296/163

(57) ABSTRACT

The present invention relates to an apparatus for rigidly mounting a load, such as a utility tray or accommodation unit, to a vehicle. The apparatus also enables demounting of the load from the vehicle such that the vehicle is free for use without the encumbrance of the load or to enable the loads to be interchanged. Particularly, a drive mechanism is included in the apparatus to selectively draw the load and vehicle together for mounting or move them away from each other for demounting.

### FIELD OF THE INVENTION

The present invention relates to a mounting apparatus for use in a vehicle assembly. In particular, although not exclusively, the invention relates to a mounting apparatus to mount a motor home to a vehicle. However, the invention is not strictly limited in its application to motor homes and may be applied to any situation where it is desirable to secure an auxiliary body to a vehicle.

### BACKGROUND TO THE INVENTION

Caravanning is a popular pastime. However, there are difficulties associated with towing a caravan behind a vehicle. In particular, inexperienced drivers may find the articulated nature of the caravan and vehicle presents difficulties in manoeuvring the caravan, especially backwards. Furthermore, accessibility of a vehicle and a towed caravan may be limited. A popular alternative is a motor home. However, there are, some distinct disadvantages associated with motor homes too. For example, once a suitable campsite base has been selected, if it is further desired to explore in the vehicle away from the campsite, the whole motor home must be packed up and the contents secured before the vehicle can be moved. This may be particularly inconvenient for small day trips from the campsite base. Another disadvantage is that the motor home incorporates a whole vehicle which is not able to be used for other requirements.

It is therefore an object of the present invention to provide an apparatus which addresses the foregoing disadvantages or at least provides the public with a useful choice.

### SUMMARY OF THE INVENTION

In accordance with a first aspect of the present invention, there is provided, an apparatus for a vehicle assembly comprising a self propelled vehicle and a load mountable to the vehicle in a mounted position relative to the vehicle and being detachable therefrom, the apparatus incorporating a drive means that includes a clamp to clamp onto a predetermined fixed portion of the load, the clamp comprising two clamping portions, one movable relative to the other between a released position and a clamping position, the clamp also being selectively movable in use on a vehicle, relative to the vehicle, to draw the load towards the mounted position and to move the load away from the mounted position on the vehicle which is selectively drivable to move the load away from the mounted position on the vehicle.

The apparatus is preferably slidably mounted to the vehicle and the apparatus is operable to overcome the frictional engagement between the load and the vehicle. In a preferred form of the invention, the apparatus is also operable to secure the load in the mounted position.

In a most preferred form of the invention, the apparatus is also operable to draw the load towards the vehicle from a tripping position relative to the vehicle to the mounted position. A tripping means may also be provided to detect when the load is in the tripping position. Preferably, the apparatus is operable to allow for the load to be partially mounted on the vehicle by driving of the vehicle, with the apparatus becoming operable to draw the load to the mounted position on the load reaching the tripping position relative to the vehicle.

The drive means is most suitably independent of the drive of the vehicle. Where the invention operates to also secure the load to the vehicle, a single drive means may be provided to move the load away from the vehicle and to secure the load in the mounted position.

The clamp may be slidable relative to the vehicle. Furthermore, the clamp may be movable in the clamping position to move the load towards the mounted position. Preferably, the clamp is movable in the released position to move the load away from the mounted position.

The two clamping portions of the clamp may comprise a forward clamping portion and a movable rearward clamping portion, the apparatus being such that when the rearward clamping portion is disposed in the released position and the predetermined portion of the load is moved adjacent to the forward clamping portion, the rearward clamping portion is driven by the drive means to be moved to the clamping position, whereupon the drive means moves the clamp and thereby the load to the mounted position. Furthermore, the apparatus may be operable such that when in the mounted position, selective operation of the drive means causes the forward portion of the clamping means to move rearwardly and thereby move the predetermined portion of the load away from the mounted position on the vehicle.

In a most preferred form of the invention, the rearward clamping portion comprises a pivotally mounted toggle driven to rotate from the released position to the clamping position, such that on being further driven, the clamp is moved forwardly. A biasing means may be provided to bias the forward portion of the clamp rearwardly.

In accordance with a second aspect of the present invention, there is provided a vehicle assembly comprising a self propelled vehicle and a load mountable to the vehicle in a mounted position relative to the vehicle and being detachable therefrom, the vehicle assembly including the apparatus according to the first aspect of the present invention.

Preferably, the load comprises an accommodation unit. Alternatively, the load comprises a tray. The load may have a single axle and a plurality of struts to support the load when detached from the vehicle.

In a preferred form of the invention, the vehicle is provided with a first guide means fixed thereto and the load is provided with second guide means fixed thereto to position the load in the mounted position relative to the vehicle wherein the first guide means is complementary to the second guide means. The guide means may be tapered to facilitate positioning of the load relative to the vehicle. Furthermore, the first and second guide means preferably each comprise elongate members.

In accordance with a third aspect of the invention, there is provided an apparatus for a vehicle assembly comprising a self propelled vehicle and a load mountable to the vehicle in a fixed mounted position relative to the vehicle and being detachable therefrom, the vehicle assembly including a mounting apparatus incorporating a drive means, the load being mountable to the vehicle in part by driving the vehicle towards the load, the drive means being activated on the vehicle reaching a tripping position relative to the load whereupon the drive means is operable to draw the load further towards the vehicle to the mounted position.

Any of the features described above in connection with the first and second aspects of the invention may have application to the third aspect set out above.

In accordance with a fourth aspect of the present invention, there is provided, a vehicle assembly comprising a self propelled vehicle and a load mountable to the vehicle in a mounted position relative to the vehicle and being detachable therefrom wherein the vehicle is provided with a first guide means fixed thereto and the load is provided with second guide means fixed thereto to position the load in the mounted position relative to the vehicle, wherein the guide means are mutually cooperative to facilitate mounting of the load to the vehicle and the guide means are tapered to facilitate positioning of the load relative to the vehicle, the first guide means being of complementary shape to the second guide means when in the mounted position.

The guide means may be of rectangular section and tapered in both dimensions of their cross-sections. Preferably, the first and second guide means each comprise a pair of spaced elongate members. In a preferred form of the invention, the members of the first guide means comprise bars of rectangular section and the members of the second guide means comprise channels, inwardly pen.

In a most preferred form of the invention, the members of the first guide means are mounted to an upwardly facing surface of a trailing portion of the vehicle and the members of the second guide means is mounted to a downwardly facing surface of a leading portion of the load such that the leading portion of the load is mounted atop the trailing portion of the vehicle in the mounted position.

### BRIEF DESCRIPTION OF THE DRAWINGS

A preferred embodiment of the invention will now be described, by way of example only, with reference to the accompanying drawings, in which:

FIG. 1 is a side view of a vehicle and an accommodation unit for mounting to the vehicle;

FIG. 2 is a side view of the accommodation unit mounted to the vehicle of FIG. 1;

FIG. 3 is a top plan view of the respective vehicle-mounted and load-mounted portions of a preferred form of the apparatus in accordance with a first preferred embodiment of the invention;

FIG. 4 is a cross-sectional view of part of the vehicle-mounted apparatus in FIG. 3 along the line A-A;

FIGS. 5A, 5B and 5C are partional cross-sectional views showing the mounting operation of the apparatus of FIG. 3;

FIGS. 6A, 6B, 6C and 6D are partial cross-sectional views showing the releasing operation of the apparatus in FIG. 3; and

FIG. 7 is a schematic diagram of the electrical circuit associated with the apparatus of FIG. 3 for controlling the operation of the apparatus.

### DESCRIPTION OF THE PREFERRED EMBODIMENT

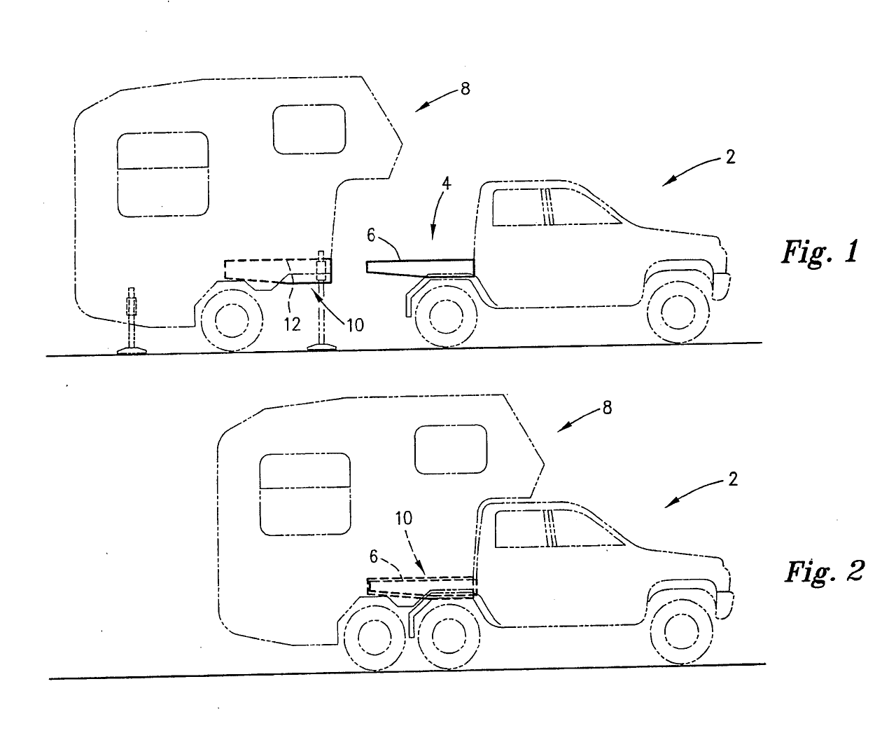

Referring to FIGS. 1, 2 and 3, a vehicle 2 has a trailing portion 4 that includes an upwardly facing surface 6 on which is rigidly mountable an accommodation unit 8 to enable transport of the accommodation unit 8 by the vehicle 2. The accommodation unit 8 includes a leading portion 10 having a downwardly facing surface 12 to which is attached a first portion 18 of a mounting apparatus 14. A second portion 16 of the apparatus 14 is incorporated into the trailing portion 4 of the vehicle 2 to project through the upwardly facing surface 6 such that the second portion 16 is engageable with the first portion 18 of the accommodation unit 8. When the respective first and second portions 18, 16 are brought together they enable rigid mounting of the accommodation unit 8 to the vehicle 2 for transport. Furthermore, the apparatus 14 enables disengagement of the accommodation unit 8 from the vehicle 2 thereby freeing the vehicle for use without the burden of the accommodation unit 8. It will be appreciated that the accommodation unit 8 is merely an example of the type of units which may be mounted to the vehicle. For instance, an alternative unit may comprise a tray for receiving a tradesman's equipment or a courier's packages.

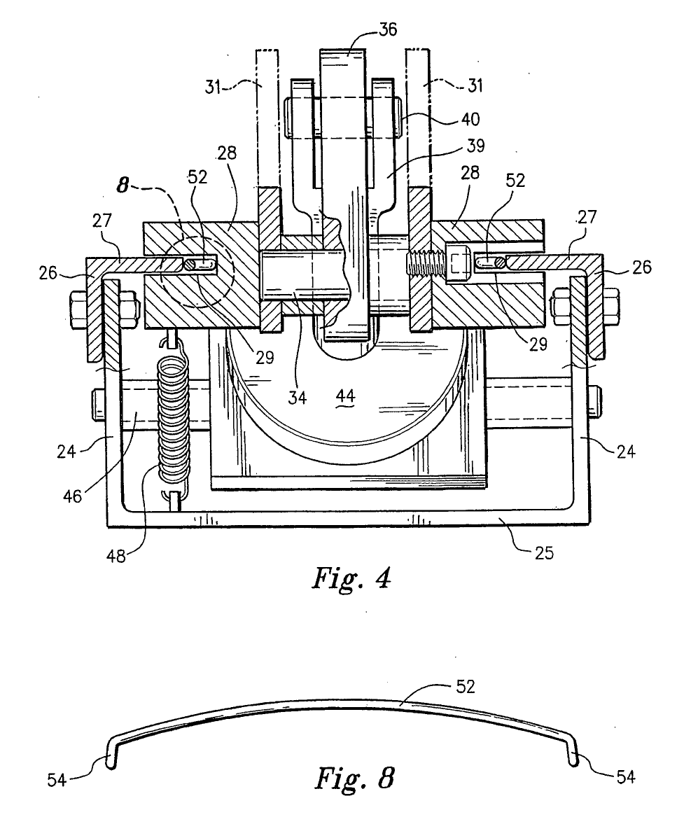

The second portion 16, which forms the drive means 20 of the apparatus 14, includes a support bar 22 linked to the chassis of the vehicle 2 and a pair of spaced walls 24 depending from the bar 22. The walls 24 are joined by floor 25 (FIG. 4) from the support bar 22. Each wall 24 has a bracket 26 attached thereto via bolts, such that a flange 27 on each bracket projects inwardly of the walls 24 to define a pair of spaced rails on which ride runners 28 of forward clamping portion 30. The forward clamping portion 30 further includes upstanding abutments 31 linked by a rigid web 32. A groove 29 formed in runners 28 receives a respective flange 27 to enable reciprocal sliding movement of the forward clamping portion 30 along the brackets 26 (FIG. 4).

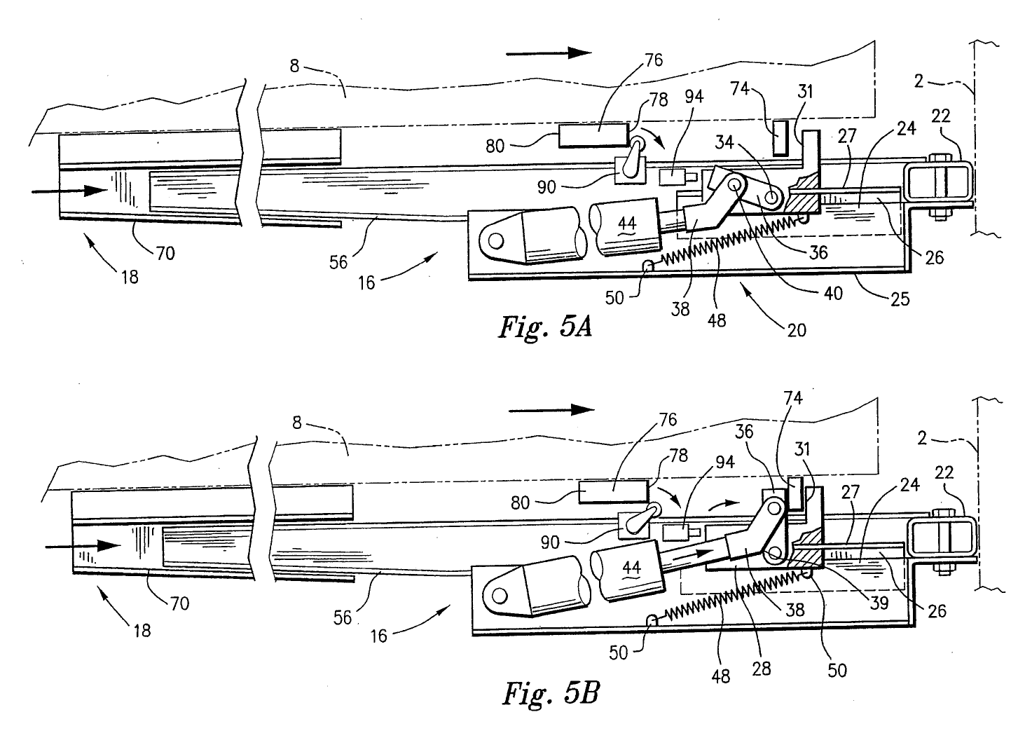

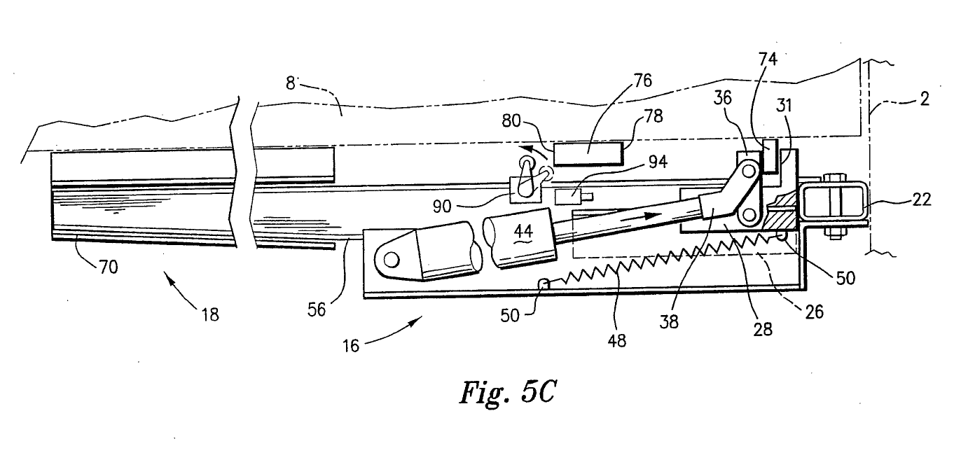

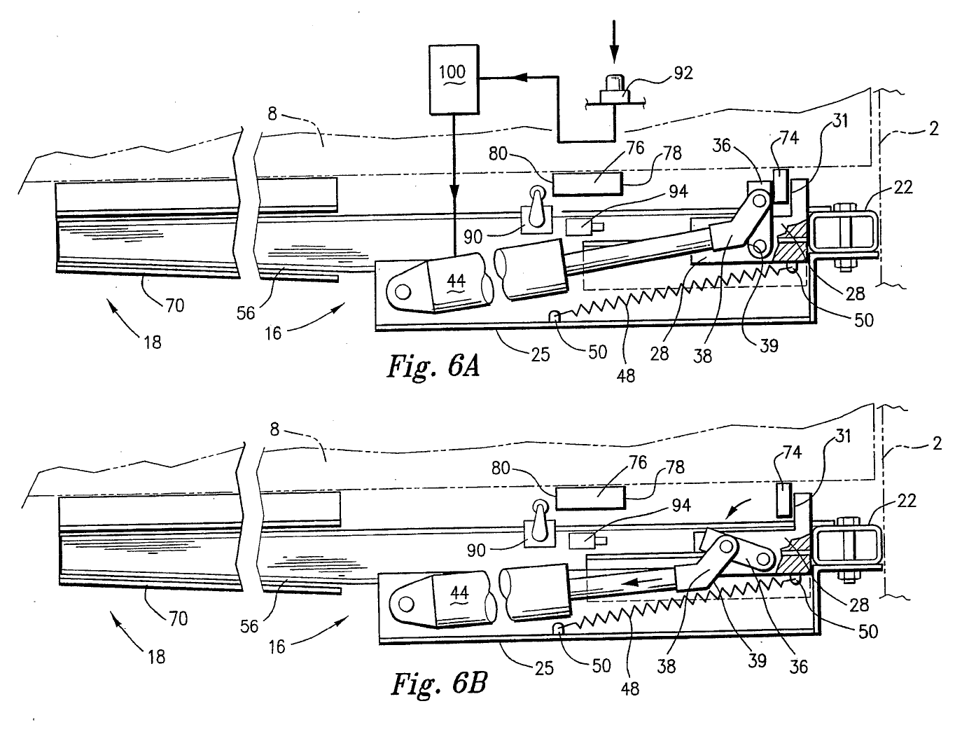

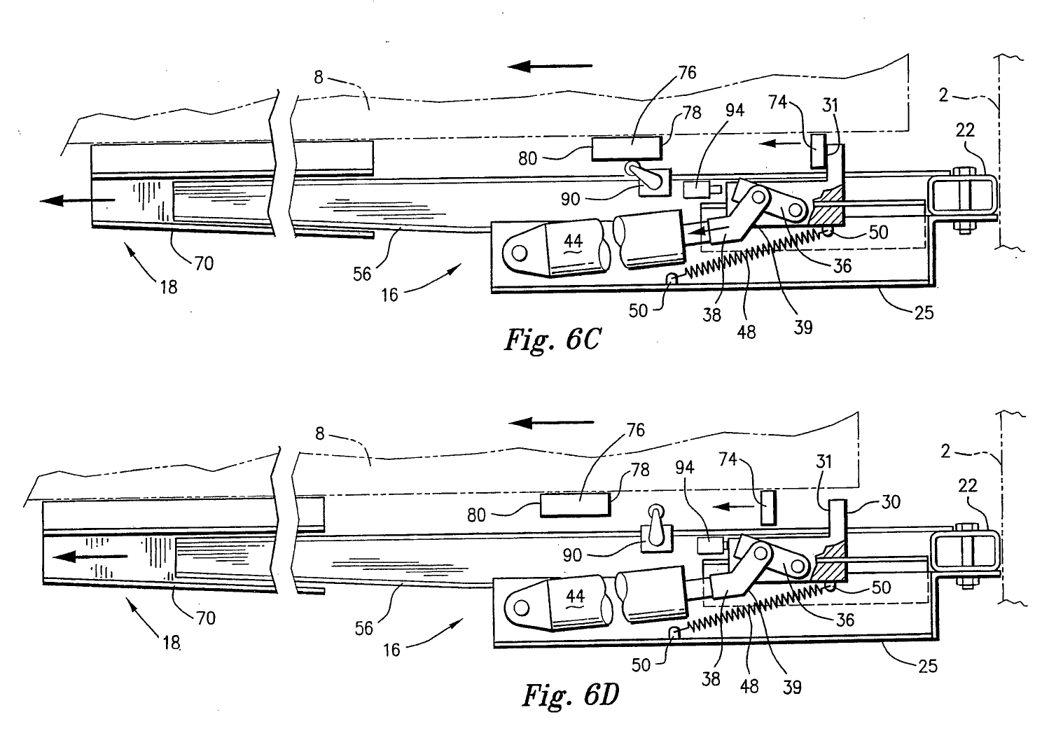

Mounted between the runners 28 midway along their length is a pivot shaft 34 on which a rearward clamping portion, formed as toggle 36, is pivotally mounted (FIGS. 5A and 5B). One end of the toggle 36 is mounted to the pivot shaft 34. Near the opposite end, a levis pin 40 is mounted to enable pivotal movement of the toggle 36 relative to a clevis 38 also attached to the clevis pin 40. The clevis 38 is mounted to an hydraulic ram 44 such that reciprocal movement of the ram 44 causes rotation of the toggle 36 relative to the forward clamping portion 30. Extension of the ram 44 causes the toggle 36 to rotate upwardly toward the abutments 31 until a face 39 of the clevis 38 contacts the side of the toggle 36 intermediate the pivot shaft 34 and clevis pin 40 to arrest further rotational movement (FIG. 5B). This is the clamping position of the toggle 36. From this position, retraction of the ram 44 causes the toggle 36 to rotate away from the clamping position to the release position shown in FIGS. 5A and 6B.

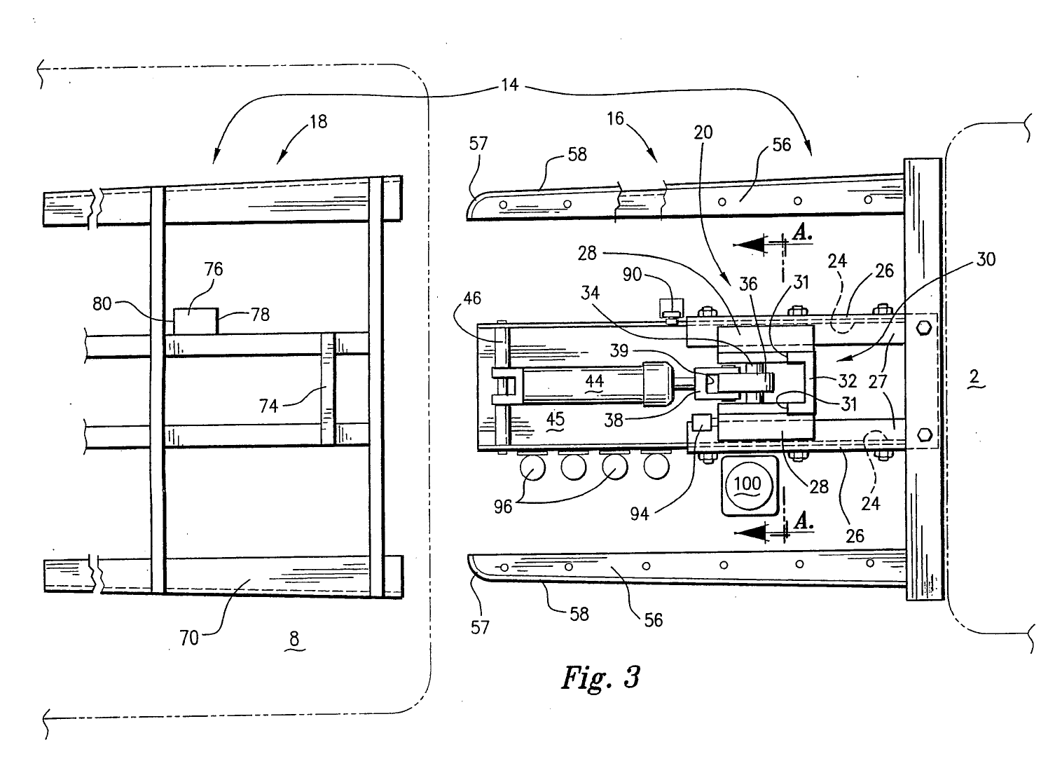

The second portion 16 further includes guide means in the form of tapered members 56 that have a teflon coating on the opposed outer sides 58 to facilitate sliding engagement with the first portion 18. A switch 90 located on one wall 24 (FIGS. 3 and 5A) is linked to a power source and activates the ram 44

A helical spring 48 fixed between projections 50 respectively located on the floor 25 and one of the runners 28 provides sufficient resistance to sliding movement of the forward clamping portion 30 such that initial extension of the ram 44 (FIG. 5B) causes the toggle 36 to pivot upwardly toward the abutments 31. In the absence of the helical spring 48, initial extension of the ram 44 may cause sliding movement of the forward clamping portion 30 away from the ram 44 such that the pick up bar 74 is not moved to the clamping position. The spring 48 is also selected such that when in the mounted position, the resistance provided by the helical spring 48 is not sufficient to overcome the frictional engagement between the tapered members 56 and channels 70 to drag the forward clamping portion 30 away from the mounted position.

An alternative to the helical spring 48 is shown in FIG. 4 in the form of a resilient wire 52 located in the groove 29 between the runners 28 and edge of flange 27. The resilient wire is formed with a curve (FIG. 8) of sufficient length such that ends 54 project from the groove 29 to engage the ends of the runners 28 thereby retaining the resilient wire 52 within the groove during sliding movement of the forward clamping portion 30.

The first portion 18 of the apparatus 14 includes spaced channels 70 shaped complimentarily to the tapered members 56 to receive the tapered members 56 in frictional engagement. The channels 70 are mounted to a frame 72 including a pick up bar 74 for clamping between the abutments 31 and toggle 36 when in the clamping position, and striker plate 76 for actuating the switch 90.

Assembly of the first and second portions 18, 16 is achieved by manoeuvring the vehicle 2 relative to the accommodation unit, such that the tapered members 56 are received in the channels 70. The rounded ends 57 of the tapered members assist with aligning the second portion 16 with the first portion 18 such that an angled or off-centre approach of the second portion 16 toward the first portion 18 will be corrected by the rounded ends coaxing the correct arrangement of the tapered members 56 within the channels 70. Further insertion of the tapered members 56 into the channels 70 brings the striker plate 76 closer to the switch 90. Upon a leading edge 78 of the striker plate 76 tripping the switch 90, the ram 44 is activated to extend the arm 42 and cause upward rotation of the toggle 36 relative to the runners 28. At the point that the ram is activated, the pick-up bar 74 is located in such proximity to the abutments 31 that the upward rotational movement of the toggle 36 captures the pick up bar 74 in a gap between the abutments 31 and toggle 36 in its clamping position (FIG. 5B). At this stage the striker plate 76 remains in contact with the switch 90 such that the ram 44 remains activated. Further extension of the ram 44 causes sliding movement of the forward clamping portion 30 such that the pick up bar 74, and associated first portion 18, moves towards a mounted position as depicted in FIG. 5C. The ram 44 is deactivated when the switch 90 disengages the striker plate 76 by falling off a trailing edge 80.

Operation of the ram 44 to drag the first portion 18 to the mounted position causes the tapered members 56 and channels 70 to frictionally engage, thereby assisting to retain the first portion 18 in the mounted position relative the second portion 16.

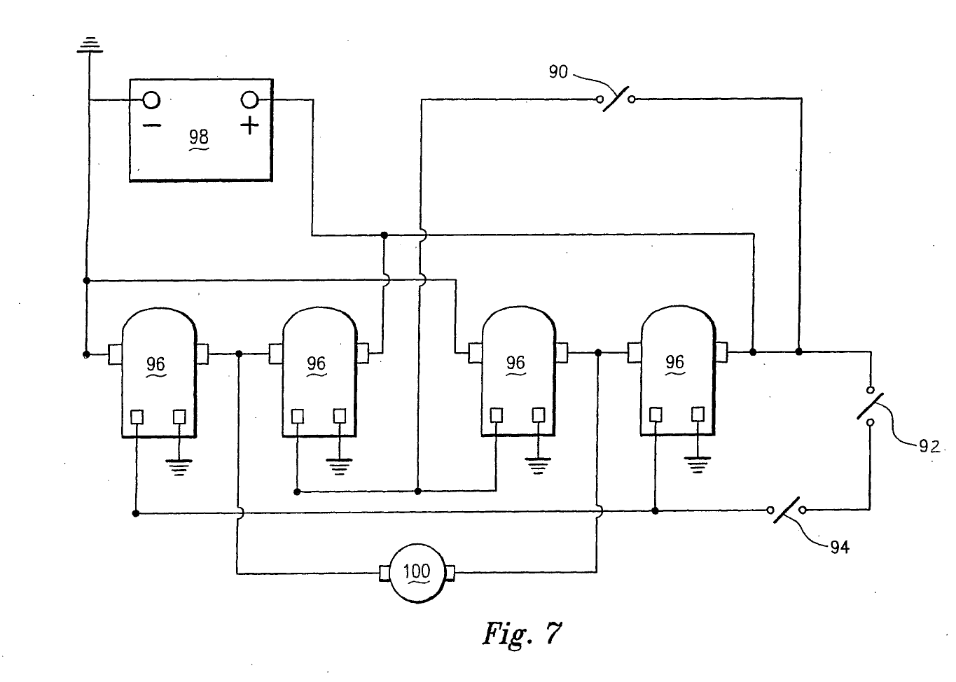

The accommodation unit 8 is disengaged from the vehicle 2 by manually actuating ejection button 92 (FIG. 7). Such actuation trips ejection button switch 93 and breaker switch 94 such that the solenoids 96 activate the ram 44 to retract (FIGS. 6A, 6B). Initially, retraction of the arm 42 causes pivotal movement of the toggle 36 away from abutments 31 thereby releasing the pick up bar 74 from clamping therebetween. As the ram is retracted, the forward clamping portion 30 is pulled toward the ram 44 along the brackets 26, whereby the abutments 31 drag the pick up bar 74 of the first portion 18 in a rearward direction thereby breaking the frictional engagement of the tapered members 56 with the channels 70 (FIG. 6C). Rearward movement of the forward clamping portion 30 is arrested when one of the runners 28 trips the breaker switch 94 (FIG. 6D) thereby breaking the solenoid circuit. At this point, the first portion 18 is free of the second portion 16 so that the vehicle 2 can be driven away free of the encumbrance of the accommodation unit 8 and used for any purpose as the driver desires.

It will be appreciated that the accommodation unit would include a number of support struts for stabilising the accommodation unit 8 when it is not engaged with the vehicle 2. Preferably, the accommodation unit 8 further includes a manually operated brake acting on the wheels of the accommodation unit 8 to further prevent movement of the accommodation unit 8 when it is free of the vehicle 2.

1-24. (canceled)

25. Apparatus for a vehicle assembly comprising a self propelled vehicle and a load mountable to the vehicle in a mounted position relative to the vehicle and being detachable therefrom, the apparatus incorporating a drive means that includes a clamp to clamp onto a predetermined fixed portion of the load, the clamp comprising two clamping portions, one movable relative to the other between a released position and a clamping position, the clamp also being selectively movable in use on a vehicle, relative to the vehicle, to draw the load towards the mounted position and to move the load away from the mounted position on the vehicle.

26. The apparatus as claimed in claim 25 wherein the load is slidably mounted to the vehicle and the apparatus is operable to overcome the frictional engagement between the load and the vehicle.

27. The apparatus as claimed in claim 25, being also operable to secure the load in the mounted position.

28. The apparatus as claimed in claim 25, being operable to draw the load towards the vehicle from a tripping position relative to the vehicle to the mounted position.

29. The apparatus as claimed in claim 28, further including tripping means for detecting when the load is in the tripping position.

30. The apparatus as claimed in claim 28, wherein the apparatus is operable to allow for the load to be partially mounted on the vehicle by driving of the vehicle, with the apparatus becoming operable to draw the load to the mounted position on the load reaching the tripping position relative to the vehicle.

31. The apparatus as claimed in claim 25 wherein the drive means is independent of the drive of the vehicle.

32. The apparatus as claimed in claim 27, wherein a single drive means is provided for moving the load away from the vehicle and to secure the load in the mounted position.

33. The apparatus as claimed in claim 25, wherein the clamp is slidable relative to the vehicle.

34. The apparatus as claimed in claim 33, wherein the clamp is movable in the clamping position to move the load towards the mounted position.

35. The apparatus as claimed in claim 33, wherein the clamp is movable in the released position to move the load away from the mounted position.

36. The apparatus as claimed in claim 33 wherein the two clamping portions of the clamp comprise a forward clamping portion and a movable rearward clamping portion, the apparatus being such that when the rearward clamping portion is disposed in the released position and the predetermined portion of the load is moved adjacent to the forward clamping portion, the rearward clamping portion is driven by the drive means to be moved to the clamping position, whereupon the drive means moves the clamp and thereby the load to the mounted position.

37. The apparatus as claimed in claim 36, being operable such that when in the mounted position, selective operation of the drive means causes the forward clamping portion of the clamp to move rearwardly and thereby move the predetermined portion of the load away from the mounted position on the vehicle.

38. The apparatus as claimed in claim 36, wherein the rearward clamping portion comprises a pivotally mounted toggle driven to rotate from the released position to the clamping position, such that on being further driven, the clamp is moved forwardly.

39. The apparatus as claimed in claim 38 wherein a biasing means is provided for resisting forward or rearward movement of the forward portion of the clamp.

40. A vehicle assembly comprising a self propelled vehicle and a load mountable to the vehicle in a mounted position relative to the vehicle and being detachable therefrom, the vehicle assembly including the apparatus as claimed in claim 25.

41. The vehicle assembly as claimed in claim 40 wherein the load comprises an accommnodation unit.

42. The vehicle assembly as claimed in claim 40 wherein the load comprises a tray.

43. The vehicle assembly as claimed in 40 wherein the load has a single axle and a plurality of struts to support the load when detached from the vehicle.

44. The vehicle assembly as claimed in 40 wherein the vehicle is provided with a first guide means fixed thereto and the load is provided with second guide means fixed thereto to position the load in the mounted position relative to the vehicle wherein the first guide means is complementary to the second guide means.

45. The vehicle assembly as claimed in claim 44 wherein the guide means are tapered to facilitate positioning of the load relative to the vehicle.

46. The vehicle assembly as claimed in claim 44 wherein the first and second guide means each comprise elongate members.

47. A vehicle assembly comprising:
a self propelled vehicle and a load mountable to the vehicle in a mounted position relative to the vehicle and being detachable therefrom,
the vehicle assembly including a mounting apparatus incorporating a drive means, the load being mountable to the vehicle in part by driving the vehicle towards the load, the drive means being activated on the vehicle reaching a tripping position relative to the load whereupon the drive means is operable to draw the load further towards the vehicle to the mounted position.
